(19) United States
(12) Patent Application Publication
(10) Pub. No.: US 2004/0193731 A1
(43) Pub. Date: Sep. 30, 2004

(54) Universal personal information connector architecture

(76) Inventor: Larry Mitchell, Toronto (CA)

Correspondence Address: HOGAN & HARTSON LLP, ONE TABOR CENTER, SUITE 1500, 1200 SEVENTEEN ST., DENVER, CO, 80202, US

(21) Appl. No.: 10/403,617

(22) Filed: Mar. 31, 2003

(51) Int. Cl. G06F 15/16

(52) U.S. Cl. 709/246; 709/203

(57) ABSTRACT

A system and method for handling personal information management (PIM) data interactions with varied client devices. The system supports many devices, PIM data types, PIM communication protocols, and PIM data store configurations. The system may run on a telematics control unit and includes a data manager providing a client-side interface to PIM data that controls local presentation, manipulation, and storage of the client PIM data. A PIM connector manager discovers client devices in the system, determines what type of PIM interface to provide for the client devices, retrieves such PIM interfaces from a PIM interface registry, registers the PIM interfaces for use by the appropriate client devices, and enables the registered PIM interfaces for use by the client devices. The PIM connector provides data and protocol conversion between the client device and the data manager and/or data store storing the client device's PIM data.

### BACKGROUND OF THE INVENTION

1. Field of the Invention

The present invention relates, in general, to computing systems with networked mobile computing and communication devices and to methods of processing personal information management (PIM) data, and, more particularly, to software, systems, and methods for providing mobile computing and communication devices with a universal connector to multiple PIM data management entities and data sources, which often employ multiple, non-compatible communication protocols and data processing applications.

2. Relevant Background

The popularity of mobile computing and mobile communication devices, such as wireless phones and pagers, laptop or personal data administrators (PDAs), and telematic systems in automobiles and other vehicles, has rapidly expanded in recent years and is expected to continue to grow such that the use of such mobile devices far exceeds the use of fixed desktop personal computers. Along with the demand for mobility, users have demanded ubiquitous access to their personal information from diversely configured mobile devices that often have limited memory and processing capacities. Besides accessing the personal data, the users want to be able to create and update this personal information on the fly and to save personal notes or messages. This personal information is typically called “personal information management” data or PIM data, and most users of mobile, and fixed or wired, devices periodically or, increasingly, frequently need to interact with their PIM data. The user may experience difficulties caused by stale PIM data or by having difficulty remotely accessing their PIM data.

PIM data generally includes numerous types of information that users of mobile and fixed devices utilize to perform their day-to-day business and personal activities. The PIM data is often stored in the memory of the device or, as is the case for many devices, is accessed as needed from a data store or PIM repository that is networked to the device. PIM data typically includes contact data, e.g., names of contacts and their telephone numbers, e-mail addresses, mailing addresses, and other information for that contact. Calendaring data such as appointments is also usually provided and arranged in the form of a daily, weekly, or monthly appointment book or planner. PIM data may also include “tasks” or “to-do lists” and other information useful to the user such as ad hoc notes or memos that may be either text, audio, or video or a combination of these data formats.

PIM access problems arise for the user because of the numerous user or client devices, the plurality of PIM data storage systems, and the various device-to-storage system techniques provided within the industry and because of the lack of consistency or standardization among these communicating entities. As the number of user devices for accessing PIM increases, problems will increase and be more difficult to solve. The problems can be understood by considering the entire user interaction with their client device and with their PIM data. On the client device, a client application locally stores, presents, and manages PIM data. For many devices, the PIM data is also stored or backed up to a remote PIM repository or data store that is linked by a wired or wireless network with the client device. During client device operation, the client device via the client application acts to retrieve data either singularly or in groups and then periodically a batch or mutual backup occurs to store or backup the data, which is typically called data synchronization or simply “synching.” PIM data access problems may not be significant for a user that operates within a system (i.e., a client device, a client application, and a PIM repository) that is provided by a single company, but such unitary systems are becoming more and more rare as mobile clients move with their user and are plugged into or connected to various computing systems, mobile devices, and PIM repositories.

In this regard, there is no shortage of client application programs that are distributed by the software and mobile device industries for use within mobile and fixed user clients for manipulating and managing the client-side PIM data and communications or interfacing with the PIM repository. Many of these client-side interfaces are built into other types of general-purpose applications such as e-mail applications. Similarly, there are many different applications that are available for use as data storage repositories, such as portal-based systems, public Internet-based repositories, and the like. Some of these applications are dual-purpose applications such as LDAP (Lightweight Directory Access Protocol) servers while others are single purpose applications that specialize in a particular function such as calendaring or data synchronization. PIM data access problems are generated because most of these various client-side and repository-side applications are configured to follow proprietary protocols that link the applications tightly to a specific client device. As a result, the client devices and the backend servers used as PIM repositories are tightly locked together and cannot interoperate effectively.

Some efforts have been made to develop a general purpose synchronization protocol. For example, the mobile device industry developed SyncML as an open industry standard for synchronization of remote PIM data in an attempt to address the non-interoperable technologies caused by the existing set of proprietary protocols used in mobile devices that functioned only with a very limited number of devices, systems, and data types. While providing a common language that could be used during synchronization of PIM data, it only attempts to solve a small portion of the problem for PIM data users. Specifically, SyncML may provide a data protocol defining a synchronization mechanism for mutual data interchange between well-defined PIM databases, but it fails to address existing legacy systems or to allow an implementer to define the interaction mechanism or protocols. Further, since the protocol is fixed in function, format, and capability, SyncML does not allow an implementer to define a small footprint implementation sized for very small footprint platforms such as cell phones, pagers, and the like.

Additionally, data synchronization addresses the need to merge and unify PIM data by changing PIM databases in repositories to be the same so that all accessed PIM data is current or up-to-date. However, an ongoing merging solution is not practical in a mobile system in which each client device has very small footprint requirements and memory is scarce. A merging solution also does not provide a desired result when a user wants to remotely access a plurality of PIM repositories and data stores with one or more client devices. Each of the client devices and repositories may be operating under different PIM client protocol models, and further, the user may wish to keep the PIM data in each repository separate and distinct (such as keeping home PIM data separate from work PIM data separate from volunteer PIM data and so on). In this case, the synchronization solution would make all the databases look the same by merging data (assuming a common protocol was used which is presently not the case), and this does not meet the needs of the user and may require memory-intensive synchronization on the client device and then backing up the synchronized PIM data. Instead, a user wants to be highly mobile and yet have all of their devices and PIM sources interconnected or interoperable. For example, a user may enter their car that is equipped with a telematics unit. The user may be carrying a wireless PDA, a MIDP or other type of cell phone, and a laptop computer with wireless capability. The user wants to be able to remotely access PIM data with any of these devices even though the PIM data may be stored in three or more data stores or repositories (such as a LDAP repository, a portal-based system, an Internet-based repository, and other data stores) and without being required to synchronize the various PIM data. The above scenario can be changed slightly by adding a second user, such as a carpooler, that also wants to access their PIM data via the same telematics unit using their mobile devices, which may or may not be similarly configured devices. With existing applications and technologies, these users would not be able to effectively access all of their PIM data.

Hence, there remains a need for an improved method and system for allowing users of fixed or mobile computing, communication, or electronic devices to remotely access, manipulate, and store (i.e., to interface with) PIM data. Preferably such methods and systems will be adapted for use with user devices having very small footprint requirements as well as devices for which memory resources are not a significant limitation. Additionally, such methods and systems preferably will be useful defining a generalized architecture for the interaction, data formatting, and data conversion between dissimilar PIM data management entities and sources.

### SUMMARY OF THE INVENTION

The present invention addresses the above problems by providing an architecture designed to handle diverse PIM data interactions with fixed clients and, more typically, mobile clients, such as cell phones and telematics or infotronics architectures provided in vehicles. The architecture is universal in that many client devices, PIM data types, PIM communication protocols, and PIM data store configurations are supported by the architecture in an ongoing and on-the-fly fashion. Generally, the architecture includes a PIM service that may be running on a telematics control unit (TCU) or other platform. The PIM service includes a PIM data manager providing a client-side interface to PIM data that controls local (i.e., on the TCU or other platform) presentation, manipulation, and storage of the client PIM data. A PIM connector manager is provided to discover client devices that are docked or otherwise in communication with the TCU or other platform and, hence, the PIM service, and in response, to determine what type of PIM interface should be provided for the client devices, to retrieve such PIM interfaces (e.g., an implementation of a PIM interface) from a PIM interface registry, to register the PIM interfaces for use by the appropriate client devices, and to enable the registered PIM interfaces for use by the client devices (e.g., to provide a connector implementation on the PIM service). The enabled PIM connector or connector implementation then functions to provide PIM data, function, and protocol conversion between the client device and the data manager and/or data store storing the client device's PIM data. The data manager in some embodiments of the invention acts to create and manage a local PIM data store on the TCU or other location that includes a cache for each client device and data store for locally storing frequently used PIM data to improve PIM data access efficiency.

More particularly, a computer-based system is provided for allowing client devices to interface with personal information management (PIM) data from multiple PIM data stores. The system includes a communication mechanism adapted, such as with wired or wireless communication ports, for communicating with client devices. A connector manager is included that functions to discover (itself or using a communication manager) a client device connected to the communication mechanism that is enabled for using a particular type of PIM data. The system includes a set of PIM connectors that are registered by the connector manager for a set of client devices. The registered set includes an implementation of a PIM connector interface selected and retrieved by the connector manager for the discovered client device based on the type of PIM data it is enabled to use. During operation, the PIM connectors provide data and protocol conversion between the set of client devices and data stores storing PIM data for the set of client devices. In one embodiment, the system includes a telematics control unit (TCU) for hosting or running the communication mechanism, the connector manager, and the registered PIM connectors. The system may further include a local data store including a cache for the discovered client device for storing a set of PIM data retrieved from one of the remote PIM data stores by the corresponding registered and enabled PIM connector.

### BRIEF DESCRIPTION OF THE DRAWINGS

FIG. 1 illustrates in block diagram of a universal PIM connector architecture or system according to the present invention showing a PIM service on a multiple client platform (such as a vehicle with a telematics control unit or a fixed computer system with multiple docking ports or stations) including a PIM data manager and a PIM connector manager for controlling registration of and implementation of PIM connectors or interfaces matched to a particular client device and corresponding PIM data accessed by the client device;

FIG. 2 is a flow chart illustrating functions performed during operation of the universal PIM connector system of FIG. 1 and, particularly, during operation of the PIM connector manager;

FIG. 3 is an exemplary class model for object coding for use in the system of FIG. 1 showing one set of useful object/class relationships between the PIM connector manager, the PIM data manager, and an implementation of a PIM connector interface;

FIG. 4 is an exemplary class model for object coding for use in the system of FIG. 1 showing one set of useful object/class relationships illustrating in a PIM data management model how PIM data is managed internally by the PIM service; and

FIG. 5 is another exemplary class model for object coding for use in the system of FIG. 1 showing one set of useful object/class relationships in a PIM data entity model basic PIM entities that may be utilized to model different types of PIM data and showing relationships between interfaces and implementations within one embodiment of the PIM service of FIG. 1.

### DETAILED DESCRIPTION OF THE PREFERRED EMBODIMENTS

The present invention is directed to addressing the need to provide data fusion or access amongst a multitude of different sorts of PIM client protocol models. The invention achieves this by providing a universal PIM connector architecture that includes a PIM service operating on a platform configured for supporting multiple client devices. The PIM service includes a PIM data manager and a PIM connector manager that together allow new “connectors” to be defined to handle one of a plurality of types of PIM data sources, data types, and/or communication protocols at the time a client device appears within the system, i.e., when a client device is connected to the multiple client platform. The multiple client platform may be a telematics control unit (TCU), which is used by the automotive industry for integrating telematic functions (i.e., hardware and software technologies to provide in-vehicle multimedia, infotainment, vehicle integration services, and remote vehicle services such as accessing PIM data from remote data stores and PIM repositories) and typically is a robust computing unit or on-board computer with limited memory and computing capacity.

The multiple client platform is typically configured to allow one or more types of client devices (e.g., personal organizers or PDAs, cell phones, pagers, laptops, notebooks, or other computing devices, screen phones, and other similar electronic devices used to access PIM data) to be connected to the platform for accessing a wired or, more typically a wireless communication network to link with remote services, such as PIM data stores and repositories. The invention provides an on-the-fly method of providing connectors for each of these devices to one or more PIM data sources without modifying or restarting the existing PIM connectors or PIM management applications. The PIM service typically also acts to cache a portion of the PIM data within a local PIM data store and to remove connectors and PIM data when it is no longer needed by a client device to address the goal of keeping a small footprint system as memory is often a scarce resource in multiple client platforms.

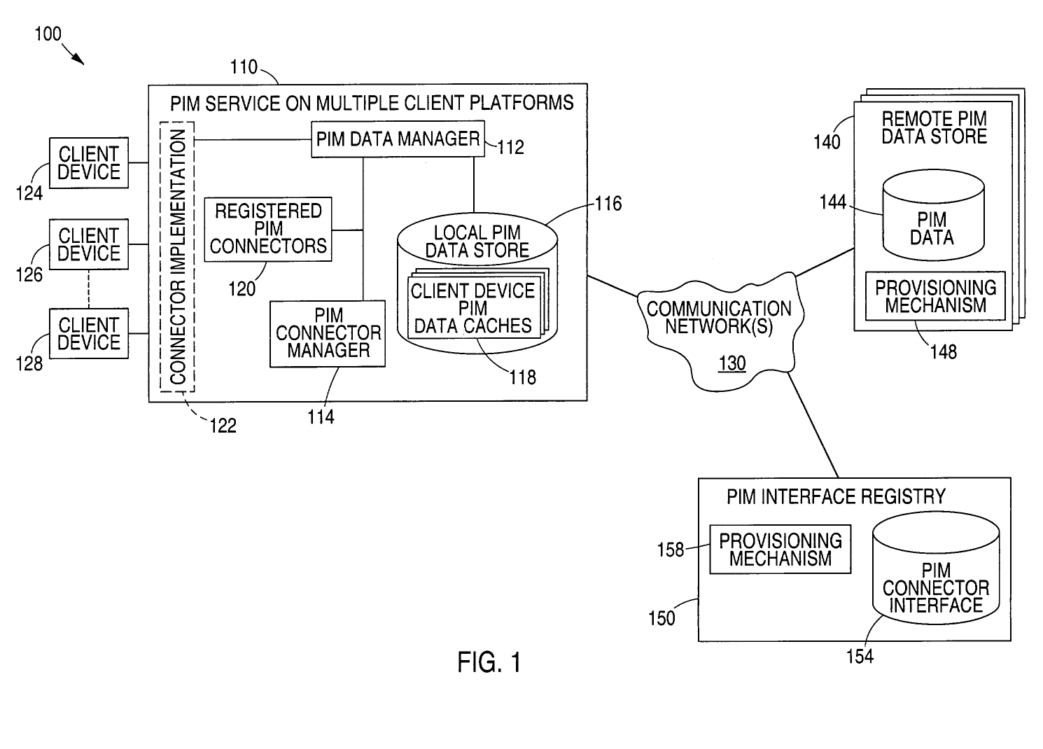

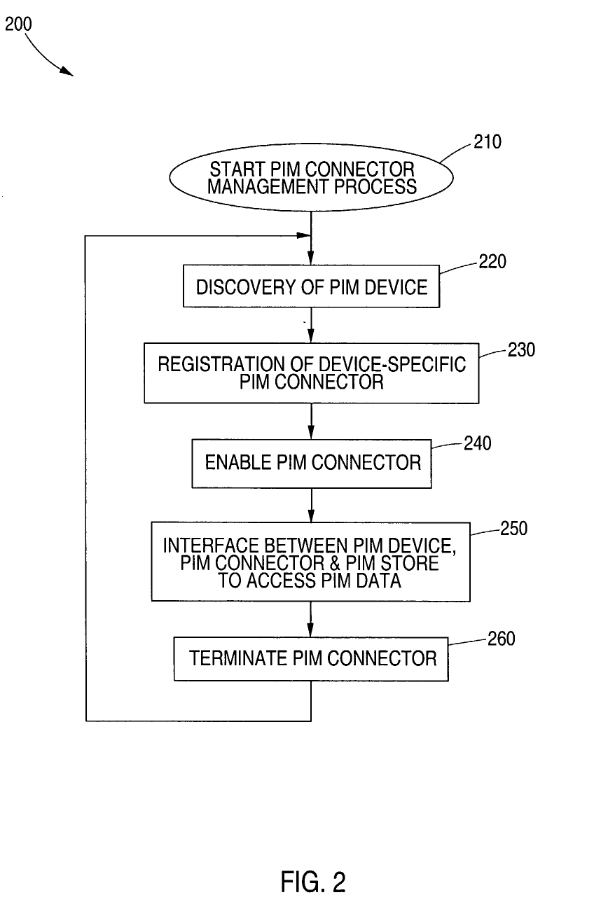

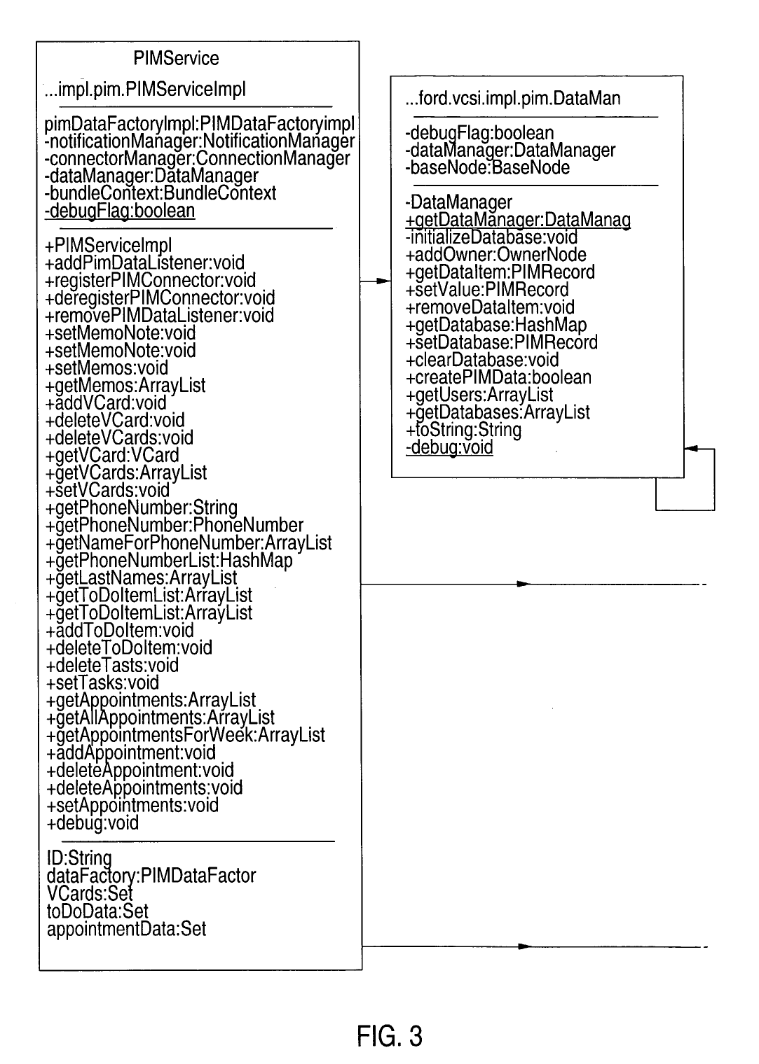

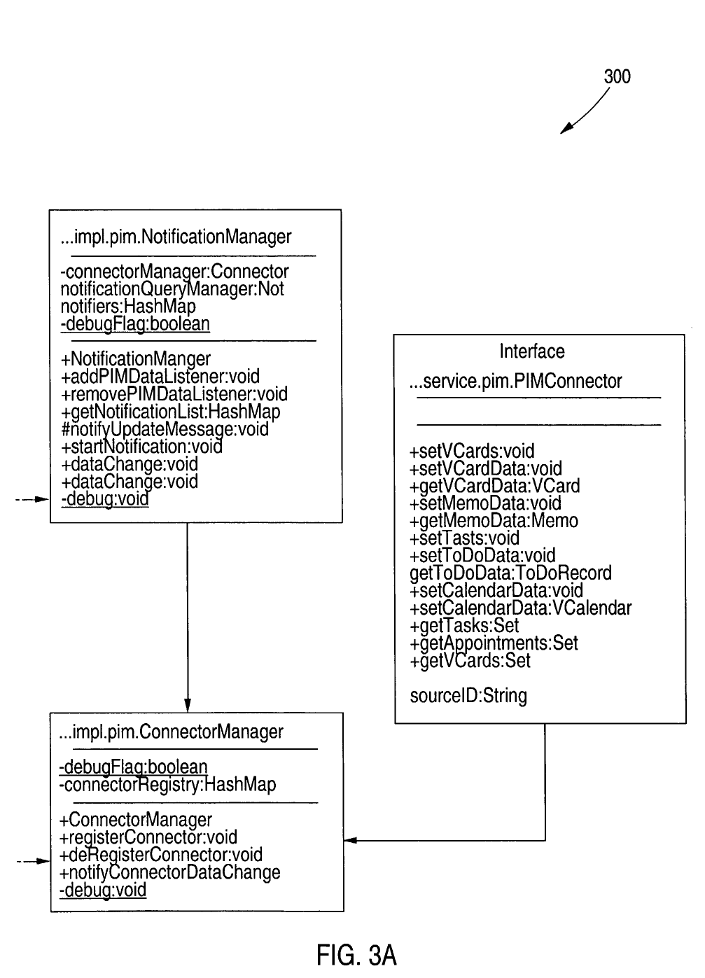

The following description begins with a discussion of a universal PIM connector system with reference to FIG. 1 describing the upper level architectural elements and their functions and interactions. The description then proceeds to a discussion of operations of a PIM service within the connector system of FIG. 1 with reference to FIG. 2 and, more particularly, operations of the PIM connector manager in managing the lifecycle of PIM connectors ranging from discovery of a new device to the removal of the device and its corresponding PIM connector. The description then proceeds to a discussion of several class models with reference to FIGS. 3-5 that illustrate exemplary implementations or models utilizing object code programming to provide the applications useful in providing the PIM connector management and connection as well as PIM data accessing and manipulation functions of the present invention.

In the following discussion, computer and network devices, such as PIM service 110 and its components, remote PIM data store 140, PIM interface registry 150, and client devices 124, 126, and 128 of FIG. 1, are described in relation to their function rather than as being limited to particular electronic devices and computer architectures. To practice the invention, the computer and network devices may be any devices useful for providing the described functions, including well-known data processing and communication devices and systems such as portions of in-vehicle computer systems, personal digital assistants, personal, laptop, and notebook computers and mobile computing devices with processing, memory, and input/output components, and server devices configured to maintain and then transmit digital data over a communications network. Similarly, the wired and wireless client devices may be any electronic or computing device for transmitting digital data over a wired or wireless network and are typically ported or communicatively-linked with computing platforms of mobile vehicles such as automobiles, airplanes, ships, mobile computers and computing devices, and the like or with computing systems or devices within stationary structures such as houses or buildings utilized by businesses and individuals. Data, including client requests, service provider or carrier and content provider requests and responses, and transmissions to and from the PIM service on the multiple client platform 110 and among other components of the universal PIM data connector system 100, typically is communicated in digital format following standard communication and transfer protocols, such as TCP/IP, HTTP, HTTPS, FTP, IMAP and the like, or IP or non-IP wireless communication protocols such as TCP/IP, TL/PDC-P, WSP, Bluetooth, 802.1 lb, and the like, but this is not intended as a limitation of the invention. Additionally, the invention is directed toward allowing access of PIM data by client devices with a plurality of PIM connectors implemented on the fly, such as PIM connector interfaces, within a multiple client platform or hosting system, such as in a telematic environment, but the invention is not limited to a specific native language within the client devices or platform, to a particular function of an application, or to a specific client configuration.

FIG. 1 illustrates a universal PIM connector system 100 according to the invention that illustrates components and communication links useful for linking a plurality of client devices with a plurality of PIM applications and PIM data types. The system 100 includes a PIM service on a multiple client platform 110 to which a plurality of client devices 124, 126, 128 are (or can be) connected or docked for passing data to and from the PIM service 110. The client devices 124, 126, 128 may, as discussed previously, be any electronic device useful for allowing a user to access PIM data such as PDAs, cell phones, pagers, and computers and may be mobile wireless devices or be wired devices such as personal desktop computers or any combination of such devices. The important aspect of the invention is that the client devices 124, 126, 128 be configured with PIM capabilities, and generally, that the PIM capabilities be unknown to the PIM service 110, e.g., requiring discovery. Further, at least some of the client devices 124, 126, 128 typically will have differing PIM capabilities or operate according to differing PIM management applications, PIM systems, PIM communication protocols, and/or PIM data types such that the PIM service 110 needs to provide 2 or more PIM connectors or connector interfaces to enable the client devices 124, 126, 128 to effectively access and manipulate their corresponding PIM data.

The PIM service 110 is provided or run on a hosting platform for linking with the client devices 124, 126, 128. In one embodiment, the PIM service 110 is provided as part of a telematics control unit (TCU) such as those used in the automotive industry but could just as easily be provided on a personal computer or other device to which multiple clients can be docked or linked to access or interface with PIM data. The system 100 further includes a communication network 130, such as a wired or wireless digital data network including wireless network, the Internet, an Intranet, a WAN, a LAN, and other useful networks or combinations of these networks. The PIM service on the platform 110 is linked to the communication network 130 to access PIM data 144 stored and managed in memory of the remote PIM data store 140.

The remote PIM data store(s) 140 may take many differing forms such as calendaring servers, synchronization managers, LDAP servers, data storage repositories, and the like that each follow one or more protocols for communicating with client devices 124, 126, 128 and for storing and managing the PIM data 144. A provisioning mechanism 148 may be provided for managing the PIM data 144 and for responding to requests from the PIM service 110 for PIM data for a client device 124, 126, 128. As with the client devices 124, 126, 128, the particular configuration of the PIM data 144 and the remote PIM data store 140 is not limiting to the invention and in most embodiments, more than one store 140 is linked to the network 130 and each of these stores 140 may differ in the PIM data formatting or type and protocols it follows. During operation, a single client device 124, 126, 128 may need to access 2 or more of the data stores 140 to retrieve or access all of its PIM data 144, and the PIM service 110 is adapted to provide a unique connector implementation 122 for each such client-data store relationship.

The system 100 further includes a PIM interface registry 150 for storing PIM connector interfaces 154 in memory of the registry 150. As will be explained in detail, the PIM connector interfaces 154 (which in some embodiments are stored locally in the PIM service 110 in memory of the multiple client platform) are a set of connectors or interfaces that are expected to be used by the PIM service 110 and are made available to the PIM service 110 via the provisioning mechanism 158 and network 130 for implementation (see connector implementation 122) by the PIM service 110 to allow a client device 124, 126, 128 to access PIM data 144 on a remote PIM data store 140 or in a local PIM data store 116 provided as part of the PIM service 110.

To provide on-the-fly connection between the client devices 124, 126, 128 and the PIM data 144 in multiple stores 140, the PIM service 110 includes a PIM data manager 112; a local PIM data store 116 with a cache 118 for storing PIM data for each client device 124, 126, 128 for each data store 140 accessed by that client device 124, 126, 128; a PIM connector manager 114; and a set of registered PIM connectors 120 in platform memory. Together these components interact to discover client devices 124, 126, 128 and to provide the appropriate connector implementation 122 to allow the devices 124, 126, 128 to access and manipulate their PIM data in cache 118 or in PIM data 144 on remote store 140.

At an upper level, the PIM data manager 112 acts to provide a client-side interface to PIM data and to this end, the PIM data manager 112 provides local presentation, manipulation, and storage of the client PIM data (such as by creating and managing the local PIM data store 116 and the PIM data caches 118). The PIM data manager 112 provides a protocol and data format neutral representation of the PIM data functionality. The responsibilities of the PIM data manager 112 within the PIM service 110 include: providing overall control of PIM functionality; providing a “neutral” interface for all PIM components; providing a “façade” interface for all applications that require interaction with PIM data and devices; and managing data flow and synchronization of PIM data.

The PIM connector manager 114 acts to manage the lifecycles of and to initiate or create connector implementations 122 for each device 124, 126, 128 having PIM capabilities (note, some client devices 124, 126, 128 may not have such capabilities and may dock with the client platform 110 for other purposes), and the lifecycle management is explained in detail with reference to FIG. 2. The PIM connector implementation 122 acts as an interface between a particular client device 124, 126, 128 and its PIM data and/or PIM applications and systems and functions to provide data, function, and protocol conversion between the data managers and data stores and the client devices 124, 126, 128.

There are two types of PIM data stores in the system 100, i.e., a remote PIM data store(s) 140 and a data store 116 local to the PIM service 110 (such as in memory of the multiple client platform). The remote PIM data store 140 is generally directly accessible except through a specified protocol, which is understood and implemented by PIM connectors in the PIM service 110 (i.e., registered PIM connectors 120 and implementations 122). The PIM service 110 further includes a local PIM data store 116 that is used to provide a cache 118 of PIM data used by the client devices 124, 126, 128 from one or more of the remote PIM data stores 140. Typically, the PIM data in the cache 118 includes frequently accessed data to enhance performance of the system 100 in accessing PIM data. The PIM data manager 112 is configured to manage the caches 118. In one embodiment, the PIM data manager 112 includes a “least recently used” caching algorithm that it uses to determine when to replace an item in one of the caches 118. More specifically, the least recently used item in a cache 118 is replaced whenever a maximum cache size for that particular cache 118 is reached and the PIM data manager 112 is issuing an order for storing another PIM data item for the corresponding client device 124, 126, 128.

The connector implementation 122 is an active element of the PIM service 110 as it interacts with the other components of the service 110 and system 100 (as can be seen more clearly in the class models of FIGS. 3-5). Nearly any client device 124, 126, 128 can be connected via the PIM service 110 to any PIM data store 140, whereby the PIM service 110 can be thought of as a universal PIM connector service and the system 100 a universal PIM data connector architecture. Primarily, this architecture is designed to manage diverse PIM data interactions with mobile client devices 124, 126, 128, e.g., cell phones in telematics or infotronics architectures and devices. A PIM service 110 similar to the one described in the class models of FIGS. 3-5 has been successfully tested by the inventor within an infotronics system (e.g., as the multiple client platform for running the PIM service 110). This tested system used a PIM management system communicating with several different PIM data clients (i.e., a cell phone and an iPaq™ computer running the PocketPC™ operating system) using Bluetooth and a proprietary or custom protocol, respectively. While this was a relatively simple testing configuration, it verified for the inventor the usefulness of the ideas described herein and of the applicability of the PIM service 110 in mapping PIM management functions to a wide variety of different devices supporting different sorts of PIM data and different PIM protocols.

As discussed previously, the PIM service 110 is effective in creating connector implementations 122 on an ongoing basis to allow the client devices 124, 126, 128 which may be added and removed from the system 100 to access PIM data in local PIM data store 116 or in a remote PIM data store 140. Each connector implementation 122 goes through a lifecycle that begins upon the discovery of a new device 124, 126, 128 and ends with the removal of the device 124, 126, 128 (or earlier), e.g., while a device 124, 126, 128 is active and connected to the PIM service 110 a connector 120 is typically registered for the device 124, 126, 128. This lifecycle is generally managed by the PIM connector manager 114, and understanding of operation of the system 100 can be achieved from following the operation of the PIM connector manager 114 and the lifecycle of a connector implementation 122.

Referring to FIG. 2, a PIM connector management process 200 is illustrated. The process 200 begins at 210 typically with the installation and configuration of the PIM service 110 on a multiple client platform (such as a TCU and the like). Step 210 may further include creation of a PIM interface registry 150 and the storing of one or more PIM connector interfaces 154 for PIM connections or interfaces expected to be required by the client devices 124, 126, 128. These PIM connector interfaces 154 typically define the interactions between a plurality of client devices and a plurality of PIM data stores and/or PIM data management services and applications. In other words, the PIM connector manager 114 acts to provide a connector implementation 122 that controls access to each PIM data source 116, 140 and provides a common interface for all PIM data sources 116, 140. The particular rules, provided by the PIM connector interfaces 154 and deployed on demand by provisioning mechanism 158, for accessing each PIM data type are encapsulated in a connector implementation 122. Some embodiments of the system 100 and process 200 include in step 210 the PIM service 110 determining (such as by user input or initial polling of client device ports) which PIM data stores 140 to connect to and the PIM data types of those stores, requesting access to PIM connector interfaces 154 that match the data types in the selected stores 140, and initiating communication links with remote PIM data stores 140 and PIM interface registry 150.

The process 200 continues at 220 with the discovery of a new client device 124, 126, 128 in the system 100. At 220, the PIM connector manager 114 acts to discover that a device 124, 126, or 128 has been connected to the platform running the PIM service 110 and also, that the device 124, 126, or 128 has PIM capabilities. Further, the PIM connector manager 114 determines what type of PIM capabilities the device 124, 126, 128 has and what PIM data (i.e., data stores 140) and PIM management is expected by the client device 124, 126, or 128. Discovery by the PIM connector manager 114 may be performed by discovery protocols or applications provided as part of the manager 114 or, more typically, by utilizing a communication manager (not shown) operating on the multiple client platform running the PIM service 110 that provides access to a protocol-specific discovery mechanism for discovery of the devices 124, 126, 128 and reporting device PIM information to the PIM connector manager.

At 230, the PIM connector is registered (with the connector or a link to the connector being stored at 120) specific to the discovered client device 124, 126, 128. More specifically, the PIM connector manager 114 acts at 230 to either download or retrieve from the remote PIM interface registry 150 one of the PIM connector interfaces 154 (such as via provisioning mechanism 158) for interfacing with the newly discovered client device 124, 126, 128. The registered PIM connector 120 is an implementation of the PIM connector interface 154 stored remotely at the registry 150. The connector program is either stored at 120 on the platform running the PIM service 110 or stored elsewhere locally or remotely but linked to the service 110 and is also “registered” with the PIM connector manager 114 as a valid connector implementation for use with the discovered client device 124, 126, 128. At 230, the connector manager 114 may register a plurality of connector interfaces for a client device 124, 126, 128 to support the device being able to access PIM data 144 in multiple stores 140 (i.e., when one device stores PIM data at multiple locations).

At 240, the registered PIM connector 120 is then enabled for acting as an interface between the particular client device 124, 126, 128 and the appropriate data store 140. In one embodiment, the PIM connector manager 114 acts at 240 to notify the PIM data manager 112 of the availability of the PIM-enabled client device 124, 126, or 128. The PIM data manager 112 then uses the connector implementation 122 (i.e., one of the registered PIM connectors 120) to access the PIM-enabled client device 124, 126, or 128. At 250, all PIM capabilities are accessible for the client device 124, 126, or 128 via its connector implementation 122. Such PIM capabilities may include accessing the PIM data 144 at a remote store 140 for viewing on the device 124, 126, or 128, altering the data and storing the revisions in the store 140, and creating and saving created notes or memos. Further, at 250, the data manager 112 typically will act to create a PIM data cache 118 at a local store 116 for future PIM data requests by the device 124, 126, or 128 via the connector implementation 122. The data manager 112 at 250 also acts to ensure that data in the caches is current and that changes to PIM data by the device 124, 126, 128 is synchronized (when appropriate) with data 144 at the remote store 140.

The lifecycle of the PIM connector implementation 122 is terminated at 260 and discovery is repeated. Termination may occur in a number of ways or be in reaction to a number of events in the system 100. A connector implementation 122 may be disabled by the PIM connector manager 114 if access to the corresponding client device 124, 126, or 128 is suspended or the incoming device requests to the PIM data manager 112 are suspended (i.e., disablement). The PIM connector manager 114 may de-register a connector implementation 122 when the PIM connector manager 114 determines that the particular connector 122 is no longer reachable (e.g., due to loss of discovery of the related PIM-enable client device 124, 126, or 128) or when the PIM data manager 112 requests that the PIM connector manager 114 remove a connector implementation 122 that is no longer needed (i.e., de-registration). The connector implementation 122 may also be configured to discover that a PIM-enabled client device 124, 126, 128 is no longer reachable or connected, e.g., that a device cannot be reached via all the existing protocols or that it has failed to respond within a specific time period. Once loss of connection is discovered or established, further retries may be attempted until the loss is deemed irrecoverable. Then once an irrecoverable condition is determined by the connector implementation 122, then the PIM connector manager 114 is notified to perform disablement and deregistration. As a result of 260, the connector implementation 122 or its presence is removed and, in most cases, the PIM connector is removed from the set of registered PIM connectors 120.

FIGS. 3-5 provide class models and relationships between aspects of the three models for one embodiment of the PIM service 110 of the system 100 of FIG. 1. It is believed that these class models provide class relationships and definitions that allow one skilled in the software arts to be able to build the entire universal PIM connector system 100 and, particularly, to implement the PIM service 110 on a host platform, such as a TCU or similar system. Because the use of such class models is well understood by those in the field of object code programming, a lengthy explanation of their teachings is believed unnecessary and is not provided.

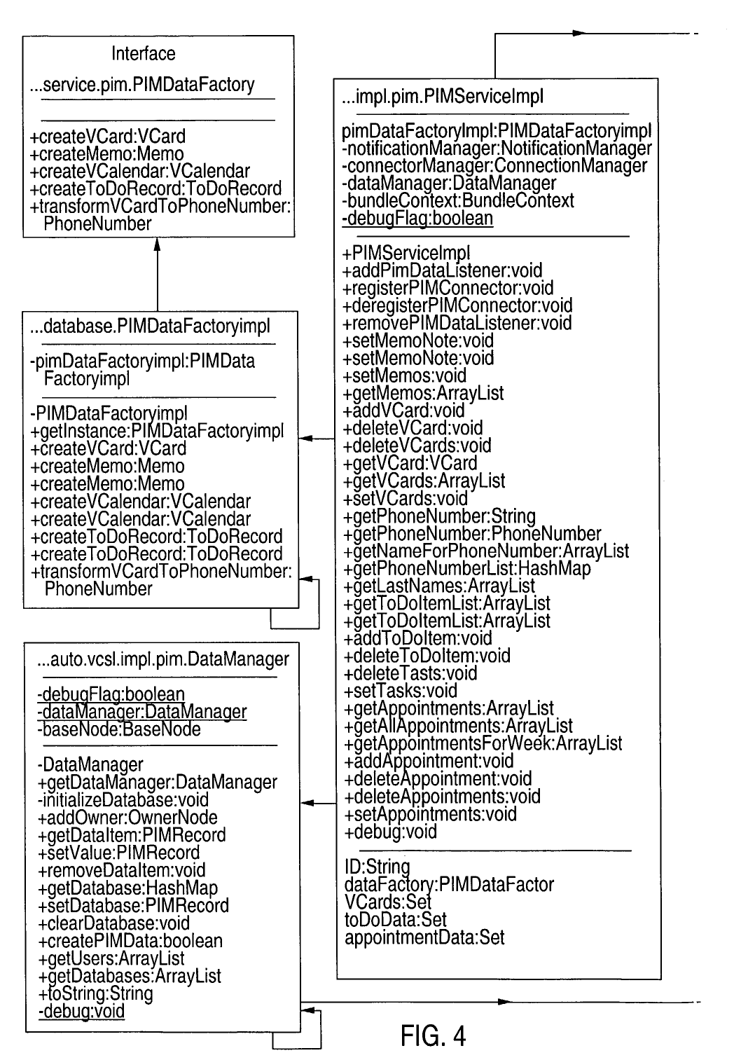

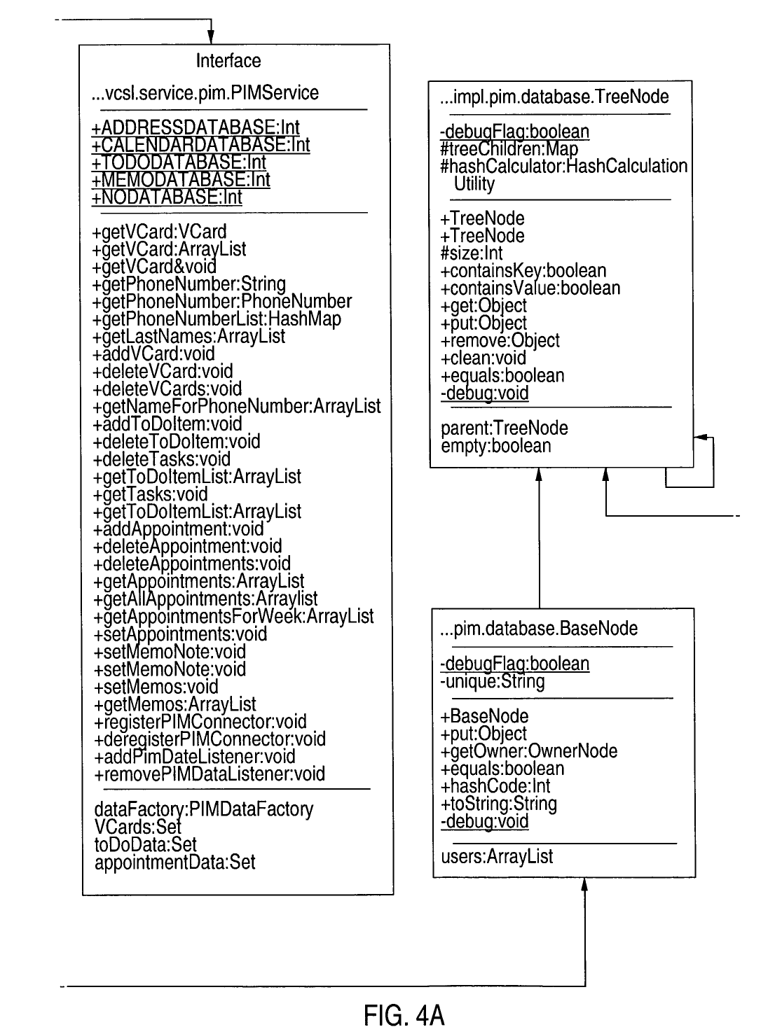

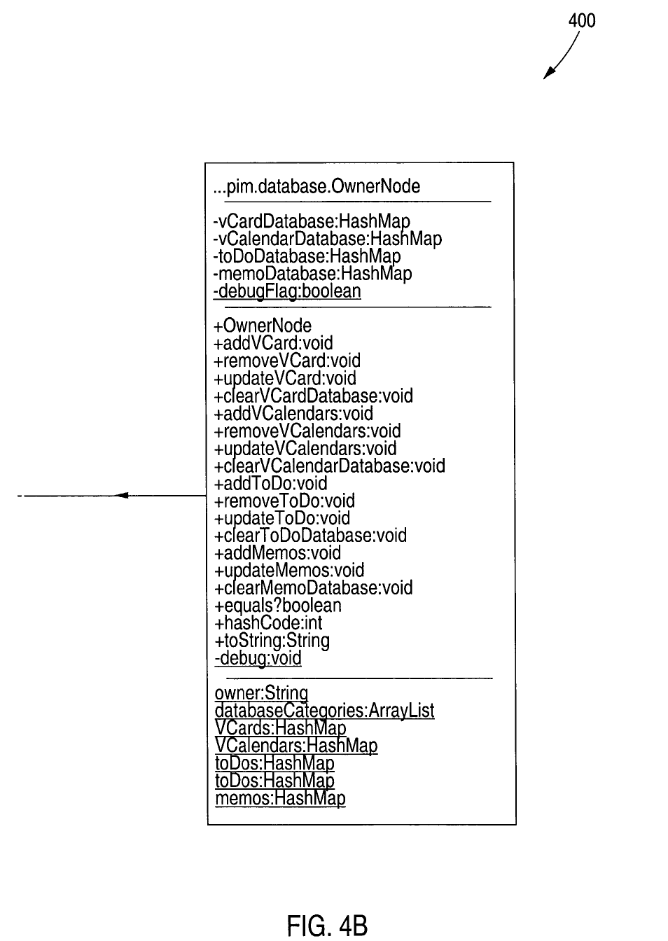

FIG. 3 illustrates a class model 300 of one useful implementation of a PIM connector, such as connector implementation 122 of FIG. 1. The model 300 illustrates a PIM service implementation (such as PIM service 110) and provides the object and class relationships between PIM connectors (such as connector implementation 122), a PIM data manager (such as PIM data manager 112), a PIM connector manager (such as PIM connector manager 114), and PIM service interfaces. As shown, but that may not have been fully explained with reference to FIG. 1, a notification manager handles PIM data messaging between the different PIM service (such as PIM service 110) components and applications that are dependent on PIM data. Note, the PIMService and DataManager interfaces of model 300 are described more fully with reference to FIG. 4.

The NotificationManager interface handles the event-based mechanisms that allow both the users of the PIM service 110 and connectors to receive notification of data changes. All data changes trigger notifications along the entire usage path. The PIMConnector represents a conduit to a remote PIM source whether this is a nearby device or a backend data source. Implementations are illustrated for each of these interfaces. The PIMConnector is a useful abstraction for allowing all such connectors to be managed without specific knowledge of their particular implementation details. The ConnectorManager provides a method for the discovery, registration, and deregistration of connectors to the PIM service 110, which allows for dynamic updating of PIM data sources without restarting the PIM service 110.

FIG. 4 illustrates a class model 400 of one useful implementation of a PIM data manager, such as manager 112 of FIG. 1. The model 400 illustrates how PIM data is managed internally by the PIM system (such as PIM service 110). As shown by model 400, one embodiment of the PIM data manager 112 acts to manage the data as a tree in the caches 118. The model 400 also provides one useful methodology for handling notification and messaging between the components of the PIM service 110.

The model 400 of FIG. 4 illustrates a low footprint implementation, i.e., an embodiment suitable for a limited embedded platform, of a database for managing PIM data. This database of model 400 is internal to the PIM service 110 and is used to create and maintain or manage an internal cache (such as in store 116) of PIM data (such as caches 118). A cache is provided in model 400 to reduce communication time by having data most often used on board the client platform. If the users of the PIM service 110 use that same type of data often enough then the PIM service 110 can retrieve this data from the cache. The structure of the cache in one embodiment is a multi-way tree. Each level of the tree represents a particular type of retrieval key.

In the model 400, there are specific classes for each element participating in the relationship. An OwnerNode represents a specific PIM service user, and each user has a specific subtree in which their data cache usage is stored. The TreeNode and BaseNode classes are used to provide the glue logic to implement the tree. The DataManager class is used to manage how and when PIM data is added to the tree used for the cache. The PIMDataFactory class is used by all sides, e.g., PIM service users and PIM connector implementations, to create new PIM data items of each of the four interface types. The DataManager will check whether to create a new element or whether or not such element is in the cache. The PIMService interface is the definition of the functionality found in the PIM service 110 with the PIMServiceImpl being the implementation of the PIMService element. All users of the PIM service 110 use the PIMService interface to access, control, manage, and manipulate PIM data.

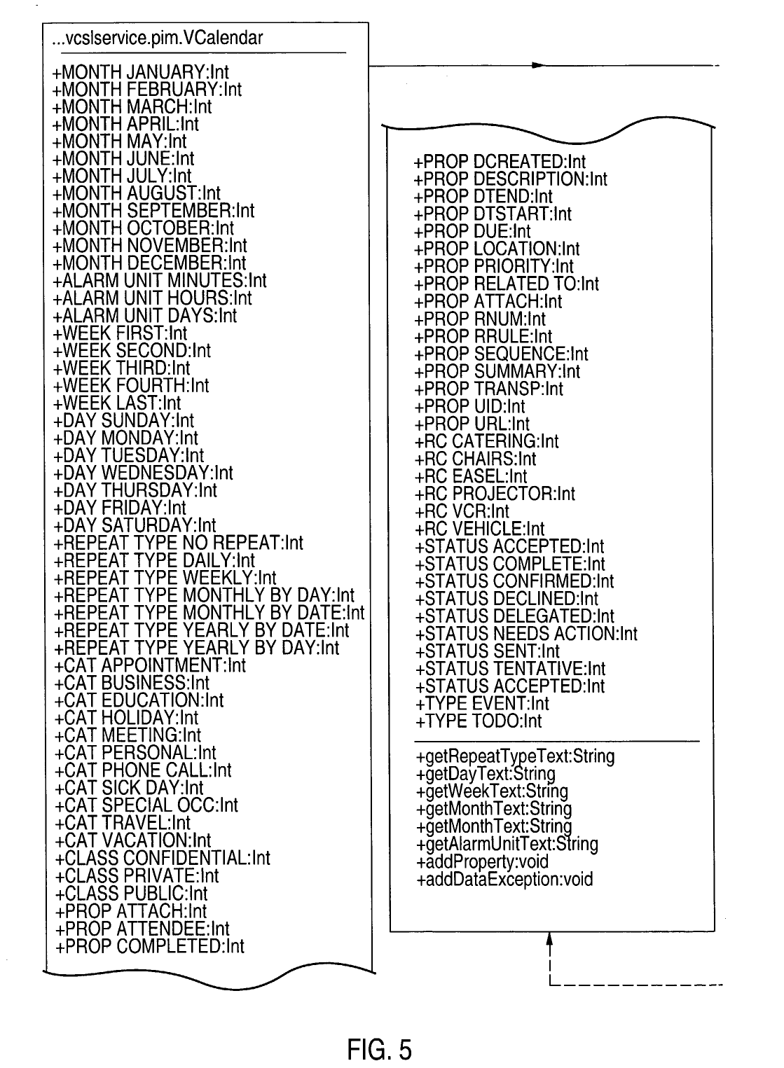

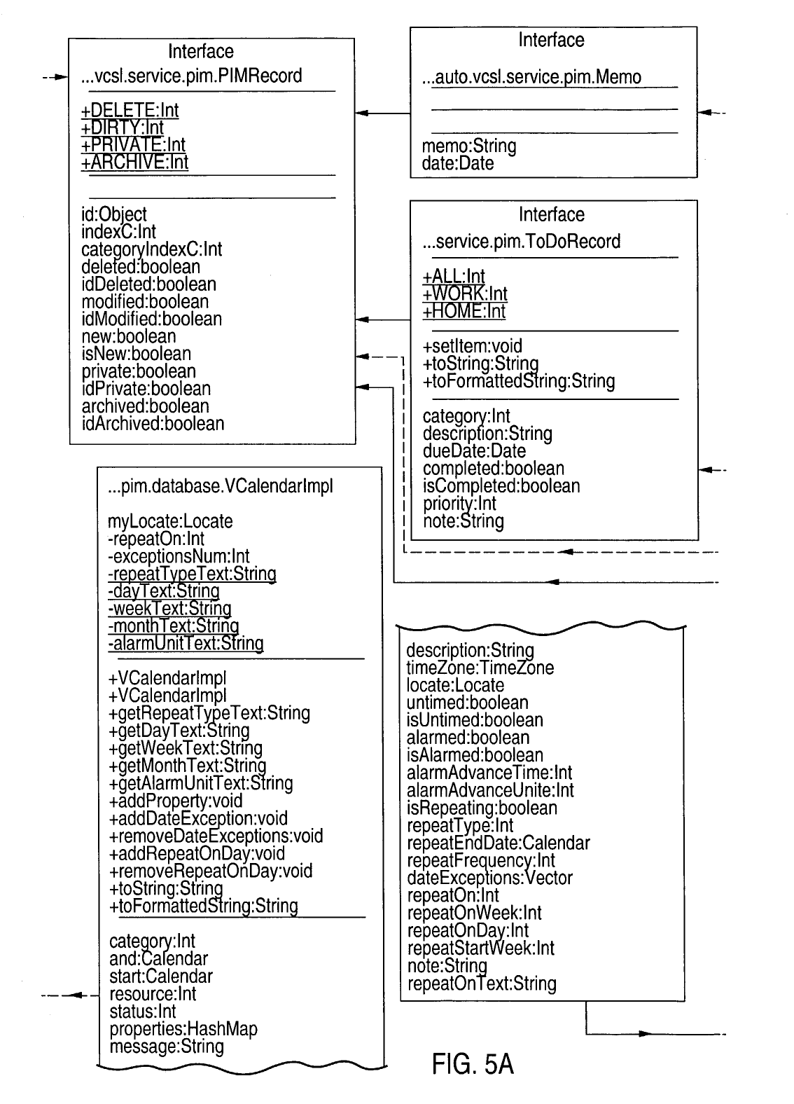

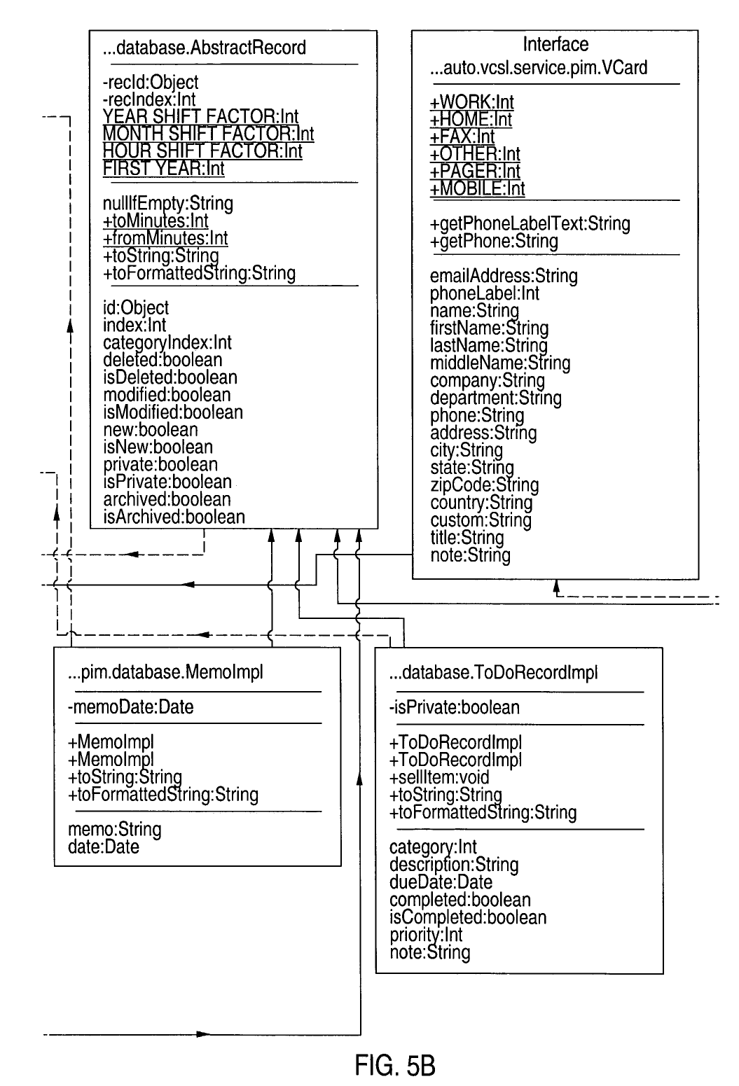

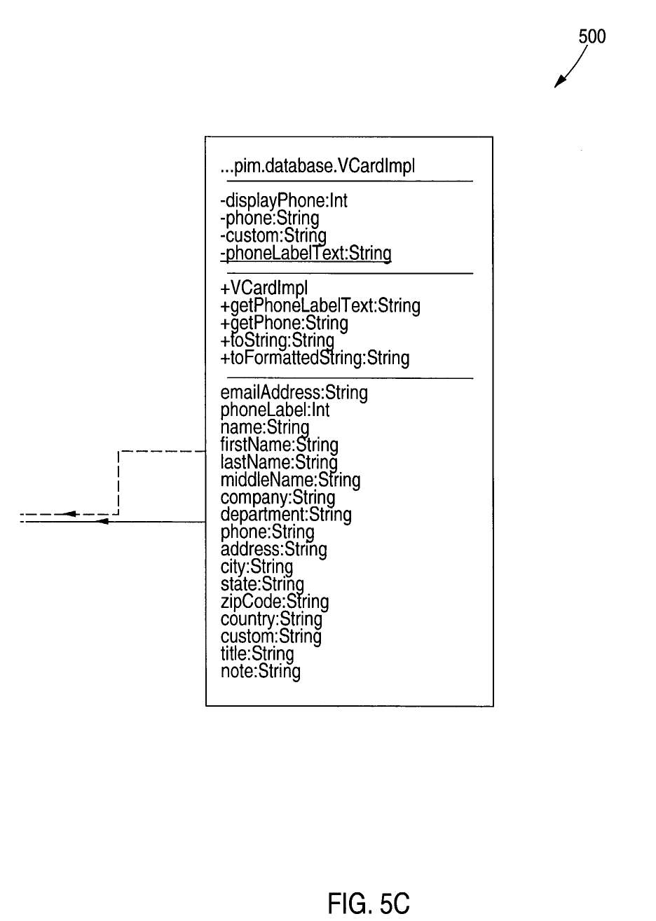

FIG. 5 illustrates a class model 500 of an embodiment of one useful PIM data entity implemented by a connector implementation with PIM data stored in cache 118. The model 500 illustrates how basic PIM entities can be used in the PIM service 10 to model different types of PIM data. The model 500 also illustrates how relationships can be defined and managed between interfaces and implementations according to the invention. As shown in FIG. 5, the model 500 shows and describes a series of four interfaces that are used to abstract information to represent PIM data, with one useful implementation of these interfaces being fully illustrated. The PIM data interfaces are used by consumers of the PIM service 110 and the abstraction of the PIM data allows service consumers to not be concerned or responsible for the exact nature or location of the PIM data. The interface implementations provide internally the specific storage and control of the PIM data.

More particularly, the VCard is the interface used for address data with VCardImpl being the implementation of this interface. Address data represents PIM data associated with contacts such as name, address, telephone, and computer contacts (e.g., e-mail). VCalendar is the interface provided for calendaring with VCalendarImpl being the implementation of this interface. Calendaring represents, for example, PIM information associated with establishing and managing appointments. ToDoRecord is the interface providing the task management function with ToDoRecordImpl being the implementation of this interface. Task management includes representing PIM information associated with the definition of a specialized type of calendar information related to performing a task that may be categorized and/or prioritized. Memo is the interface included for abstract types of notes whether these are in text, audio, or video form with MemoImpl being the implementation of this interface. The remaining classes and interfaces included in the model 500 function to provide helpers to simplify the four implementations of the interfaces. For example, PIMRecord is an interface that provides a common interface that is the basis of all the PIM interfaces. The AbstractRecord class is the common base for all implementations and acts to handle common implementations for all the PIM classes.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

I claim:

1. A computer-based system for allowing client devices to interface with personal information management (PIM) data from multiple PIM data stores, comprising:
a communication mechanism adapted for communicating with client devices;
a connector manager discovering a client device connected to the communication mechanism that is enabled for using a type of PIM data; and
a set of PIM connectors registered by the connector manager for a set of client devices including an implementation of a PIM connector interface selected and retrieved by the connector manager based on the type of PIM data determined for the discovered client device, wherein the PIM connectors provide data and protocol conversion between the set of client devices and data stores storing PIM data for the set of client devices.

2. The system of claim 1, wherein the connector manager further discovers loss of communication with the discovered client device at the communication port and in response, removes the implementation of the PIM connector interface selected for the discovered client device from the set of registered PIM connectors.

3. The system of claim 1, wherein the connector manager further discovers an additional client device linked to the communication mechanism that is enabled for using an additional type of PIM data differing from the type of PIM data used by the discovered client device and in response, selects and retrieves based on the additional type of PIM data an implementation of an additional PIM connector interface, the implementation of the additional PIM connector interface being added to the set of registered PIM connectors for later use by the additional client device.

4. The system of claim 1, further including a local data store including a local cache for the discovered client device storing a set of PIM data retrieved from the PIM data store for the discovered client device by the registered PIM connector corresponding to the implementation of the PIM connector interface corresponding to the discovered client device.

5. The system of claim 1, further including a connector implementation comprising the implementation of the PIM connector interface corresponding to the discovered client device that has been enabled by the connector manager for allowing the discovered client device to access the PIM data stored for the discovered client device.

6. The system of claim 1, further including a telematics control unit hosting the communication mechanism, the connector manager, and the set of registered PIM connectors.

7. The system of claim 1, further including an interface registry linked by a communication network with the connector manager, the interface registry storing a set of PIM interface connectors configured to support a set of PIM-enabled client device and PIM data store configurations.

8. The system of claim 7, wherein the connector manager creates the set of registered PIM connectors by discovering a set of client devices linked to the communication mechanism, retrieving one of the PIM interface connectors in the interface registry for each one of the set of client devices based on PIM enablement of the client devices, and registering the retrieved PIM interface connectors for use by the corresponding client devices.

9. A computer-based method for providing access connections for client devices to personal information management (PIM) data, comprising:
discovering a client device enabled for PIM data;
determining an interface to a PIM data source for the discovered client device;
registering a PIM connector for the discovered client device, wherein the PIM connector is an implementation of the determined interface; and
enabling the registered PIM connector for use by the discovered client device, whereby the enabled PIM connector controls access to PIM data on the PIM data source by the discovered client device.

10. The method of claim 9, further including:
discovering an additional client device enabled for PIM data,
determining an interface to an additional PIM data source for the additional client device;
registering a PIM connector for the additional client device, wherein the PIM connector for the additional client device is an implementation of the determined interface for the additional client device; and
enabling the PIM connector registered for the additional client device.

11. The method of claim 10, wherein the PIM data source and the additional PIM data source operate utilizing differing protocols to manage stored PIM data.

12. The method of claim 10, wherein the PIM connector for the discovered client device differs from the PIM connector for the additional client device.

13. The method of claim 9, further including creating a cache in a local data store corresponding to the discovered client device and the PIM data source storing a set of the PIM data accessed by the enabled PIM connector.

14. The method of claim 9, further including terminating the enabled PIM connector including determining loss of discovery of the discovered client device.

15. The method of claim 9, further including operating the enabled PIM connector to perform PIM data, PIM data function, and PIM data protocol conversion to allow the discovered client device to access the PIM data.

16. A method for linking client devices with personal information management (PIM) data sources, comprising:
establishing a communication link with a client device;
discovering the client device including determining whether the client device is enabled for a type of PIM data and determining PIM data sources storing PIM data for the client device;
for each of the PIM data sources, registering a connector configured to enable the client device to access the client device PIM data in one of the PIM data sources; and
enabling one of the registered connectors for use by the client device as an interface with a corresponding one of the PIM data sources.

17. The method of claim 16, further including:
establishing a communication link with an additional client device;
discovering the additional client device including determining a type of PIM data for which the additional client device is enabled and determining PIM data sources storing PIM data for the additional client device; and
for each of the PIM data sources for the additional client device, registering a connector configured to enable the additional client device to access the client device PIM data.

18. The method of claim 17, wherein the type of PIM data determined for the client device differs from the type of PIM data determined for the additional client device.

19. The method of claim 16, further including discovering loss of the client device and in response, terminating the enabled one of the registered connectors.

20. The method of claim 16, further including creating a local store including a cache for the client device for each of the PIM data sources storing PIM data retrieved by the connectors registered for use by the client device from the PIM data sources.
